(19) United States
(12) Patent Application Publication
(10) Pub. No.: US 2012/0270995 A1
(43) Pub. Date: Oct. 25, 2012

(54) AQUEOUS FORMULATIONS INCLUDING DIOXOLANES AS COUPLING AGENTS

(75) Inventors: Daniela Hauffe Bonifacio, Campinas (SP) (BR); José Denilson Vicentim, Campinas (SP) (BR); Paulo Roberto Garbelotto, Campinas (SP) (BR)

(73) Assignee: RHODIA POLIAMIDA E ESPECIALIDADES LTDA, Sao Paulo (BR)

(21) Appl. No.: 13/503,617

(22) PCT Filed: Oct. 22, 2010
(86) PCT No.: PCT/IB2010/002705

§ 371 Date: Jul. 9, 2012

(30) Foreign Application Priority Data
Oct. 23, 2009 (FR) FR0957458

(51) Int. Cl. C09D 125/14

(52) U.S. Cl. 524/562

(57) ABSTRACT

An aqueous coating formulation including a polymer resin, an inorganic filler and a dioxolane as a coupling agent is described. Aqueous paint formulas including certain dioxolanes as coupling agents are also described.

The present invention pertains generally to aqueous coating formulations comprising a polymer-based resin, an inorganic filler and a dioxolane as coupling agent. The invention pertains more particularly to aqueous paint formulas comprising certain dioxolanes as coupling agents.

### PRIOR ART

Fillers, which have both inorganic and hydrophobic features, are compounds that are widely employed in paint formulas with the aim of enhancing the performance characteristics associated with the mechanical properties, with the cost of the formulas and with the inflammability characteristics. The fillers commonly employed include talc, calcium carbonate, glass fibre, alumina trihydrate and magnesium hydroxide. The polymers commonly employed in such formulas are organic in nature, and the addition of an inorganic particle to the medium, such as these fillers, is capable of adversely affecting the principal properties of the resin. Coupling agents are employed in order to prevent or minimize these negative effects.

Coupling agents reduce the side effects of adding fillers to a polymeric system by interacting with the filler and the resin. The coupling agents exhibit two different and opposite polar behaviours within the same molecule. The non-polar behaviour originates from the carbon chain of the compound. Lengthening the carbon chain increases the polar and non-polar characters. The polar behaviour originates from polar groups such as —OH which are present in the structure. These groups interact with the surface of the filler via hydrogen bonds. The coupling agents are therefore capable of interacting with the non-polar resin and with the polar surface of the fillers, acting like a bridge between them, and preventing any unwanted loss of performance properties on the part of the filler or of the polymer. A number of types of coupling agents are known. In the list of organic compounds, glycols are the substances which in structural terms exhibit the characteristics of effective coupling agents. Examples of glycols commonly employed include butylglycol, butylglycol acetate, ethylglycol acetate and methylglycol.

Although these are known coupling agents which are employed in compositions comprising fillers and organic resins, there is constant research effort undertaken in order to find effective alternatives which are simple to use and are less toxic.

### DESCRIPTION OF THE INVENTION

The present invention relates, generally, to the use of the compound of formula (I) as a coupling agent between a polymer-based resin and an inorganic filler, in an aqueous coating formulation;

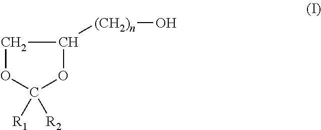

where R1 and R2 are identical or different and are selected from a hydrogen atom and alkyl, alkenyl and phenyl groups, n being an integer between 1 and 5.

R1 and R2 represent, independently of one another, preferably a methyl, ethyl, n-propyl or isobutyl group. Moreover, particularly, n is 1 or 2. 2,2-Dimethyl-1,3-dioxolane-4-methanol, called solketal (CAS number 100-79-8), is especially preferred. It is also possible to use, for example, 2,2-diisobutyl-1,3-dioxolane-4-methanol, also known by the acronym IIPG, of the synonym 1-isobutylisopropylidene glycerol.

In the text below, solketal is stated only as a dioxolane appropriately representing the present invention, without this in any way confining the scope of the invention to that compound alone.

The compound of formula (I), then, is able to act as a coupling agent. The —OH group is involved in polar interactions, especially hydrogen bonds, with the inorganic fillers, and the carbon alpha to the —OH group is involved in non-polar reactions, especially van der Waals bonds, such as London dispersion forces, with the polymeric resin. Other interactions may also participate in the coupling effect on the inorganic fillers and the polymeric resin in the aqueous coating formulation.

As shown by Table 1 below, the majority of known organic coupling agents are short- to medium-chain glycols where the non-polar moiety may be separated from the polar moiety by an oxygen atom. Although the oxygen acts as a bridge responsible for this separation within the molecule, it also contributes, albeit to a lesser extent, to the formation of hydrogen bonds. The weaker interaction of the oxygen atom alone relative to the hydroxyl group originates from steric effects, in other words from the fact that the volume occupied by the alkyl chain is greater than that occupied by the hydrogen atom. The longer the alkyl chain, the lesser the strength of the hydrogen-oxygen bond. The selection of the compound to be employed is important in so far as different alkyl chain sizes give different results in terms of evaporation and coalescence time, depending on the interaction with the resin and the filler.

TABLE 1
Comparison of various coupling agents with solketal

| | | Vapour point | Acute oral | | | | Aquatic |
|---|---|---|---|---|---|---|---|
| | Flash point | in mmHg | toxicity | Skin | Eye | | toxicity |
| Substance | in ° C. | (20° C.) | in mg/kg | irritation | irritation | CMR | in mg/l |
| Butylglycol | 62 | 0.8 | 1950 | moderate | severe | A3 | 1720 |
| Butylglycol | 78 | 0.4 | 2360 | weak | weak | A3 | 103.17 |
| acetate | | | | | | | |
| Ethylglycol | 47 | 2.0 | 2900 | severe | severe | cat. 2 | 244.66 |
| acetate | | | | | | | |
| Methylglycol | 107 | 6.2 | 18 000 | weak | severe | N/A | 18 000 |
| Ethylglycol | 40 | 5.3 | 3000 | moderate | weak | cat. 2 | 5000 |
| | | (25° C.) | | | | | |
| Ethyldiglycol | 93 | 0.1 | 5500 | severe | severe | N/A | 13 400 |
| | | (25° C.) | | | | | |
| Solketal | 80 | 52.0 | 7000 | moderate | moderate | A4 | >1000 |
| | | (37.8° C.) | | | | | |

(CMR = carcinogenic/mutagenic/reproductively toxic)

Table 1 also shows that solketal has one of the highest flash points, and therefore less risk associated with skin or eye irritation, and also has a low oral toxicity figure. Accordingly, the toxicity characteristics of solketal in respect of human health and safety are the lowest of all of the most commonly employed coupling agents, thereby making this compound extremely useful, reliable and easy to handle.

When an organic compound evaporates, it undergoes a number of types of distinct reactions with the compounds in the atmosphere. One of the most important of these is the formation of ozone, owing to the presence of volatile organic compounds (VOCs). It should not, however, be supposed that different VOCs react in the same way and generate the same amount of ozone. The amount of ozone formed in the reaction depends on two main factors:

different reaction mechanisms between the VOCs and NOx, owing to different classes of organic compounds;

the reaction kinetics specific to the different organic compounds.

Accordingly, one of the effective methods of controlling the formation of ozone is to control VOC emissions on the basis of their reactivity in the atmosphere, by lowering emissions of more reactive compounds. Without being bound by this theory, it is thought that this type of comparison is appropriate when the aim is to minimize the formation of ozone due to VOC emissions, since it incorporates the fact that different compounds generate different amounts of ozone depending on their reactivity.

Maximum incremental reactivity (MIR) is a measure attaching to numerous organic compounds, and represents the formation of ozone in situations where the level of NOx is adjusted to give the maximum ozone formation. The parameter, which represents the maximum possible amount of ozone formed by a specific VOC, is expressed in “gO₃/gVOC” (grams of ozone per gram of VOC). The lower the value of MIR, therefore, the lower will be the impact on the environment. Table 2 lists the MIR values of certain important coupling compounds, by comparison with solketal.

TABLE 2
MIR values of organic compounds

| SUBSTANCE | MIR in gO₃/gVOC |
|---|---|
| Butylglycol | 2.79 |
| Butylglycol acetate | 1.67 |
| Ethylglycol acetate | 1.90 |
| Methylglycol | 0.92 |
| Solketal | 2.01 |

Butylglycol and methylglycol have the highest and lowest MIR values respectively. Between these two values, the four other compounds have relatively close MIR values, solketal included. Solketal is therefore suitable for all applications, without giving rise to severe or unexpected environmental impact, since its MIR value is similar to that of numerous coupling agents used which do not represent a substantial environmental risk.

The formulation comprises preferably from 0.1% to 5% by weight of compound of formula (I), relative to the total weight of the composition.

Inorganic fillers in a coating formulation are understood to be the hard components, and may exhibit different functionalities.

It is especially preferred to use fillers in the formulation that are inorganic fillers and are able to interact with the —OH function of the dioxolane of the invention via polar interactions. Interactions of this type may come about with the —OH function of the dioxolane if the fillers exhibit the following functions in particular: —OH, —NH3, carboxylic acid, acrylic or epoxy.

The fillers commonly employed in coating formulations are, for example, carbonate fillers, such as calcium carbonate, silicate fillers such as kaolin, talc and mica, siliceous fillers such as silicas, or else barium sulphate, glass fibres, glass beads, alumina trihydrate and magnesium hydroxide. The silicas may be expanded or colloidal. The glass fibres may be chopped or ground.

The formulation comprises preferably from 5% to 20% by weight of fillers, relative to the total weight of the formulation.

The polymers commonly employed in the formulas of the invention are organic polymers. They include more particularly vinyl polymers such as polyvinyl acetate and polyvinyl alcohol, acrylic resins such as acrylic-styrene polymer, vinyl-acrylic resins, and epoxy resins, polyamides and polyesters, their homopolymers, copolymers and terpolymers.

The formulation comprises preferably from 20% to 60% by weight of polymer, relative to the total weight of the formulation.

In one advantageous application of the invention, the aqueous formulas are, in particular, aqueous paint formulas.

The formulation of the invention is preferably an acrylic-based aqueous latex paint.

The formulation preferably comprises no glycol coupling agent, such as the glycols that are commonly employed, including butylglycol, butylglycol acetate, ethylglycol acetate and methylglycol.

The formulation according to the invention may further comprise other compounds that are generally used in the art, such as, especially, pigments, biocides, surfactants, preservatives and driers.

The formulations according to the invention are prepared in ways that are conventional in the art. The various additives are generally added to water that has been brought to a temperature allowing effective mixing of the different components.

A specific language is used in the description in order to make it easier to understand the principle of the invention. It should nevertheless be understood that no limitation on the scope of the invention is intended through the use of this specific language. Modifications, improvements and optimizations may in particular be envisaged by a person skilled in the art in question, on the basis of his or her own general knowledge.

The term “and/or” includes the meanings and, or, and all possible other combinations of the elements connected by this term.

Other details or advantages of the invention will emerge more clearly from a reading of the examples given below solely by way of indication.

### EXPERIMENTAL SECTION

The examples below are given only as particular applications of the invention, and are not intended to represent further limitations relative to the claims hereinafter.

Three formulas of aqueous paint are prepared, as shown below in Table 3. A reference formula contains no coupling agent; formula A contains a known coupling agent, propylene glycol monomethyl ether; and formula B, according to the invention, contains solketal as coupling agent.

TABLE 3
Aqueous paint formula tested (styrene acrylic resin - latex)

| | % by | | | Formula B |
|---|---|---|---|---|
| Component | weight | Reference formula | Formula A | (invention) |
| Solvent | 25.35 | water | ″ | ″ |
| Ionic | 0.42 | low molecular | ″ | ″ |
| dispersant | | mass polyacrylate | | |
| | | dispersant | | |
| Wetting | 0.20 | ethoxylated | ″ | ″ |
| agent | | nonylphenol | | |
| Anti- | 0.05 | sodium nitrite | ″ | ″ |
| corrosion | | | | |
| agent | | | | |
| Antifoam | 0.30 | oily antifoam | ″ | ″ |
| agent | | agent | | |
| Pigment | 14.00 | titanium dioxide | ″ | ″ |
| Filler | 11.00 | precipitated | ″ | ″ |
| | | calcium carbonate | | |
| Coalescent | 1.00 | diisobutyl ester | ″ | ″ |
| agent | | | | |
| Coupling | 1.5 | none | propylene | solketal |
| agent | | | glycol mono- | |
| | | | methyl ether | |
| Base | 0.20 | ammonium | propylene | ″ |
| | | hydroxide | glycol mono- | |
| | | | methyl ether | |
| Biocide | 0.10 | 1,2-benziso- | propylene | ″ |
| | | thiazolin-3-one | glycol mono- | |
| | | | methyl ether | |
| Thickener | 0.88 | hydrophobically | propylene | ″ |
| | | modified anionic | glycol mono- | |
| | | thickener | methyl ether | |
| Emulsion | 45.00 | acrylic-styrene | propylene | ″ |
| | | emulsion | glycol mono- | |
| | | | methyl ether | |
| TOTAL % | 100.00 | | | |

The comparison of the performance qualities is shown in Table 4 below:

TABLE 4
Comparison of performance properties

| | Reference | Formula A | Formula B |
|---|---|---|---|
| TEST | formula | (prior art) | (invention) |
| Paste | 15 | 15 | 15 |
| thickness (μm) | | | |
| pH | 8.80 | 8.83 | 8.80 |
| Krebs | 89.3 | 87.4 | 85.7 |
| viscosity (KU) | | | |
| Covering power | low relative | standard | similar to |
| (wet) visual | to formula A | | formula A |
| comparison | | | |
| Covering power | low relative | standard | similar to |
| (dry) visual | to formula A | | formula A |
| comparison | | | |

The tests of Table 4 were carried out in accordance with the following indications:

Paste thickness: used to evaluate the dispersion of the paint. Standard: ABNT NBR 7.135 (Brazilian standard)

pH: measured with a pH meter.

Viscosity (Krebs): must be at the right level to allow proper spreading of the paint. Standard: ABNT 12.105 (Brazilian standard) and ASTM D 562.

Covering power: evaluated by comparison for a wet layer and a dry layer.

Abrasion: test carried out in a Gardner apparatus, measured in cycles. Standard: ASTM D 1.300.

From the information presented in the present invention and the results in Table 4 it is possible to conclude that the performance properties of the paint including the dioxolanes according to the invention, for example solketal, as coupling agent are satisfactory relative to an aqueous paint formulated with a glycol coupling agent.

1. A method of using a compound as a coupling agent, the method comprising using as the compound a compound of formula (I) as a coupling agent between a polymer-based resin and an inorganic filler, in an aqueous coating formulation; 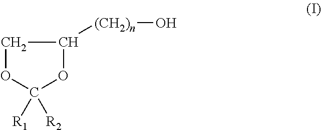
where R1 and R2 are identical or different and are selected from a hydrogen atom, an alkyl, an alkenyl and a phenyl group, n being an integer ranging from 1 to 5.

2. The method as defined by claim 1, wherein R1 and R2 represent independently of one another a methyl, an ethyl, an n-propyl or an isobutyl group.

3. The method as defined by claim 1, wherein n is 1 or 2.

4. The method as defined by claim 1, wherein the dioxolane is 2,2-dimethyl-1,3-dioxolane-4-methanol.

5. The method as defined by claim 1, wherein the inorganic fillers have the following functions: —OH, —NH₃, carboxylic acid, acrylic or epoxy.

6. The method as defined by claim 1, wherein the inorganic fillers are selected from the group consisting of a carbonate filler, a silicate filler, a siliceous filler, a glass fiber, a glass bead, an alumina trihydrate and a magnesium hydroxide.

7. The method as defined by claim 1, wherein the formulation comprises from 5% to 20% by weight of fillers, relative to the total weight of the formulation.

8. The method as defined by claim 1, wherein the polymer-based resin is selected from the group consisting of a vinyl polymer, an acrylic resin, a vinyl-acrylic resin, an epoxy resin, a polyamide and a polyester, a homopolymer thereof, a copolymer thereof and a terpolymer thereof.

9. The method as defined by claim 1, wherein the formulation comprises from 20% to 60% by weight of polymer-based resin, relative to the total weight of the formulation.

10. The method as defined by claim 1, wherein the formulation is an aqueous paint formula.

11. The method as defined by claim 1, wherein the formulation is an acrylic-based aqueous latex paint.

12. The method as defined by claim 1, wherein the formulation does not comprise a glycol coupling agent.
